(19) United States
(12) Patent Application Publication
(10) Pub. No.: US 2007/0101257 A1
(43) Pub. Date: May 3, 2007

(54) Electronic file re-formatting tool

(75) Inventors: Dean Lynn, Hertfordshire (GB); Thomas E. Chase, Welwyn Garden City (GB); Tomas E. G. Bystrom, London (GB); Satyan K. Vadher, Middlesex (GB)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/250,755

(22) Filed: Oct. 14, 2005

(51) Int. Cl. G06F 17/00

(52) U.S. Cl. 715/516; 715/530; 715/526

(57) ABSTRACT

An electronic file decomposition system is illustrated. A parser of the electronic file decomposition system decomposes an electronic file into different components based at least in part on metadata of the components. An interface of the electronic file decomposition system presents an interactive representation of the decomposed electronic file to a user. The user employs the interface to select components to retain and/or components to remove. A re-formater of the electronic file decomposition system generates a new electronic file based on the received electronic file and the user selections.

### BACKGROUND

The embodiments herein relate to re-formatting electronic files. They find particular application to parsing and describing an electronic file based at least in part on metadata associated therewith and selectively retaining and/or discarding one or more portions of the electronic file based on the description.

Continual advances in computer and electronic based technologies have revolutionalized the manner in which information is disseminated. For instance, whereas information was predominately distributed in paper form, the trend is to additionally or alternatively distribute such information in electronic form (e.g., webpages, word processing documents, spreadsheets, etc.). Many markets and/or individuals are leveraging the benefits (e.g., reduction in costs, increased efficiency, record maintainability, etc.) associated with electronic information and shifting paradigms to paperless (or minimal paper usage) forms of communication.

As electronic information become ubiquitous, pervading virtually every market across the globe, authors, owners, and/or distributors of electronic information are using creative marketing techniques to appeal to their audiences and/or gain a competitive advantage. By way of example, a typical webpage may have inclusions such as one or more advertisements, images, animations, hyperlinks, menus, executables (e.g., applets), etc. In some instances, such inclusions are not associated with the main content being presented. For example, a portion of the webpage may be sold or leased for unrelated advertisements. In other instances, even though the inclusions are related to the main content, they merely impede and/or do not add value to the observer of the content. For example, images may be interleaved with text.

In some instances, the observer generates a hard copy of the information. For example, the observer may utilize mapping software to obtain directions to a destination. Depending on the complexity of the directions, the observer may print a hard copy which can be carried with the observer when traveling to the destination. If the directions include various advertisements, images, animations, hyperlinks, menus, executables, etc. dispersed throughout, these inclusions will print on the hard copy, cluttering the main content and/or unnecessarily consuming marking media.

Conventional techniques for eliminating such extraneous information within an electronic file include highlighting a desired portion and only printing the highlighted portion through an option provided in a print menu and/or copying the electronic file and manually removing extraneous information. When using the print menu, the user typically has a limited flexibility. For instance, the user typically can only highlight contiguous sections. Thus, advertisements that are interleaved between desired text cannot be highlighted without also highlighting desired text. When copying the content of the page to an editor, formatting (e.g., color, emphasis, background, etc.) may change, various features may not resolve, and the observer is tasked with identifying and manually removing undesired sections, which may again change the formatting (e.g., layout).

### BRIEF DESCRIPTION

In one aspect, an electronic file decomposition system is illustrated. This system includes a parser that decomposes an electronic file into different components based at least in part on metadata of the components. An interface presents an interactive representation of the decomposed electronic file to a user who uses the interface to select which components to retain and/or which components to remove. A re-formater subsequently generates a new electronic file based on the received electronic file and the user selections.

### BRIEF DESCRIPTION OF THE DRAWINGS

FIG. 1 illustrates a system that facilitates identifying, separating, and representing different components of an electronic file;

FIG. 2 illustrates one or more elements of an analysis tool that facilitates parsing an electronic file into its components;

FIG. 3 illustrates one or more elements of an analysis tool that facilitates presenting and re-formatting a parsed electronic file;

FIG. 4 illustrates a system having an interactive display to remove and/or modify various portions of an electronic file;

FIG. 5 illustrates a non-limiting example in which the analysis component is used to facilitate removing undesired elements from an electronic file in order to mitigate printing undesired elements;

FIG. 6 illustrates a method for identifying and removing portions of en electronic file; and

FIG. 7 illustrates a method for removing undesired elements of a webpage during a printing process in order to selectively print sections of interest.

### DETAILED DESCRIPTION

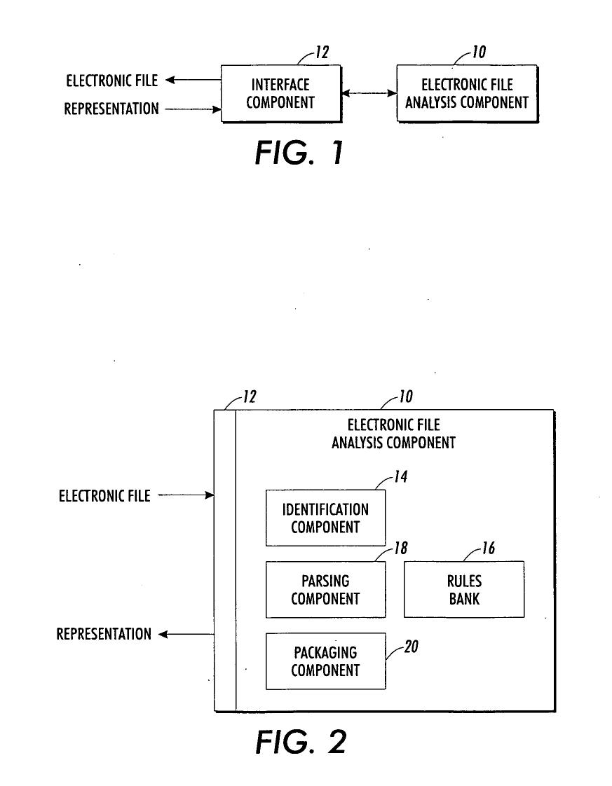

With reference to FIG. 1, a system that facilitates identifying and removing portions of an electronic file is illustrated. The system includes an electronic file analysis component (“analysis component”) 10 that receives an electronic file and generates a representation that describes the content of the electronic file. By way of example, the analysis component 10 may receive a webpage, which can include various elements including, but not limited to, text (e.g., explaining and/or describing a main or other topic of the webpage), and images, advertisements, hyperlinks, embedded executables, etc. related and/or unrelated to the text. The analysis component 10 can identify such elements within the webpage and generate a corresponding representation delineated by element.

The analysis component 10 can use various techniques to determine the format (e.g., webpage, spreadsheet, word processing document, etc.) of the electronic. For example, the source (e.g., a user, an application, etc.) of the electronic file may reveal the format to the analysis component 10, the electronic file may include format identifying indicia, and/or the analysis component 10 may scrutinize the electronic file and determine its format. Upon determining the format of the electronic file, the analysis component 10 can decompose the electronic file based on the elements therein. Such decomposition can be achieved by analyzing metadata associated with the content of the electronic file. For instance, a typical webpage is generated from source code (e.g., programmed in markup languages such as html, xml, etc.) that includes the data to display as well as data about the data to display (metadata), including structural, descriptive, presentational, etc. information. The analysis component 10 can use the metadata to parse the electronic file into different groupings of elements. For instance, the analysis component 10 can use the metadata to identify advertisements, menus, a header, etc.

The analysis component 10 can subsequently generate a representation of the electronic file, delineating the electronic file by the different groupings of elements. In one instance, this representation can be viewed by a user who can determine which elements to retain (e.g., desired elements) and/or which elements to discard (e.g., undesired elements). In another instance, a pre-stored configuration and/or profile can be used to automatically identify elements to retain and/or elements to discard. In yet another instance, intelligence (e.g., inference engines, neural networks, classifiers, etc.) can be used to select elements to retain and/or discard (e.g., through statistics, heuristics, probabilities, historical information, confidence intervals, etc.). Upon determining which elements to retain and/or elements to discard, the representation and/or selections can be used to generate a new electronic file (e.g. a new webpage) that includes the desired or retained content, but does not include the undesired or discarded content.

The new and/or original electronic file can be saved to storage for subsequent viewing and/or further processing, including, but not limited to, further processing by the analysis component 10 to remove other content and/or for printing. The ability to remove undesired sections prior to printing allows the user to remove unrelated information and generate more concise prints, and reduce the amount of marking media (e.g., ink, etc.) consumed, which can reduce printing cost. Alternatively, the new electronic file may only be temporarily stored. For instance, a temporary file excluding the undesired content can be created, forwarded to another application (e.g., a printing application), and discarded after further processing. For example, the temporary file can be conveyed to a print utility, wherein the new electronic file is printed to media (e.g., paper, velum, plastic, etc.), but not electronically stored for future utilization. In another example, parsed data can be made available for further processing, including changing page layout, modifying content location, etc.

The system further includes an interface component 12. The interface component 12 provides various input and/or output communication interfaces for the analysis component 10. For example, the interface component 12 can provide interfaces to one or more web browsers, word processors, image viewers, etc. These interfaces provide protocols, drivers, etc. to except electronic files from and/or convey electronic files to essentially any application, machine, computing system, etc. in virtually any format. For example, the interface component 12 may include a web browser interface for accepting and/or conveying html based electronic files. This allows the analysis component 10 to receive html based web pages, parse the web pages as described above, generate an html or other format-based representation, and provide such representation to the source application, machine, system, a display, a computing system, etc.

It is appreciated that the analysis component 10 and/or the interface component 12 can be implemented in software, hardware, and/or firmware. In addition, the analysis component 10 and/or the interface component 12 can be a distinct system, part of a computing system, distributed (e.g., over one or more networks, etc.), etc. Further, the analysis component 10 and/or the interface component 12 can be associated with one or more applications, drivers, add-ons, plug-ins, etc.

FIG. 2 illustrates one or more elements of the analysis component 10. The analysis component 10 can include an identification (ID) component 14. The analysis component 10 can employ the identification component 14 to facilitate determining the format of a received electronic file. For example, the source (e.g., a user, an application, a computer, etc.) of the electronic file can provide the format of the electronic file to the identification component 14. In another example, the identification component 14 can analyze the electronic file to determine its format. For instance, the identification component 14 can read a header associated with the electronic. In another instance, the identification component 14 can read metadata such as one or more tags associated with the electronic file. In situations where the identification component 14 is unable to identify the format of the electronic file, the identification component 14 can request such information, for example, from the source of the electronic file, etc., guess the file format, transmit a notification (e.g., an error warning, a message to the source, etc.) that the it is unable to determine the electronic file format, and/or ignore the electronic file.

The analysis component 10, upon determining the format of the electronic file, can obtain one or more algorithms associated with the file format from a rules bank 16. The one or more algorithms can provide information (e.g., syntax, semantics, etc.) about the particular file format that can facilitate decomposing the electronic file into groups of different elements. For example, the one or more algorithms may define various tags and/or other indicia associated with html based source code.

A parsing component 18 can use the one or more algorithms to parse the electronic file into different elements. For instance, the tags and/or other indicia can be used to identify similar and/or different elements within the source code. For example, an html image tag such as “IMG” may be used in connection with images embedded within a webpage. The one or more algorithms can provide such information to the parsing component 16, which can use this information to locate images within the webpage.

A packaging component 20 can suitably package the various elements that comprise the electronic file. In one instance, the packaging component 20 can create a representation of the electronic file, showing the various elements. For instance, the packaging component 20 can generate a list of the different elements that comprise the electronic file. The list can sorted by appearance (e.g., from top to bottom and/or left to right) within the electronic file, by element (e.g., header, images, advertisements, etc.), relation to the main topic (e.g., related, unrelated, unknown relation, etc.), user customized settings, etc. In another instance, the packaging component 20 can create a user interface that graphically describes regions of the electronic file. With this instance, an advertisement in the electronic file may be replaced with the “advertisement” and/or with other indicia in the representation of the electronic file.

The representation can be further processed to remove undesired data from the electronic file. The representation and/or selections can be used to generate a new electronic file that includes desired content and that does not include the undesired content.

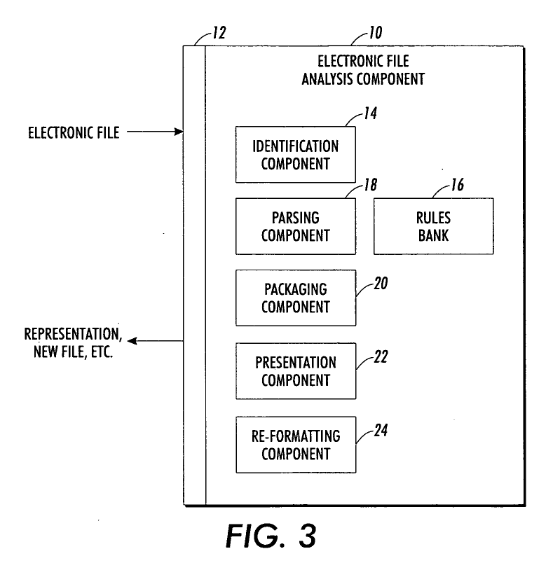

In FIG. 3, the analysis component 10 further includes a presentation component 22 and a re-formatting component 24. The presentation component 22 provides an interface to view and/or interact with the representation. The interface may include a graphical and/or command line interface in which a user can view and/or input information. For instance, the interface may include graphics that identify various elements of the electronic file and/or the location of such elements. The interface may additionally include one or more mechanisms with which the user can identify an element as an element to retain and/or an element to remove. For example, the interface may show the location of an advertisement within the electronic file. Additionally, the interface can include a means for selecting and/or deselecting each advertisement. Such means can include highlighting the advertisement, marking a box, etc.

It is to be appreciated that the interface can display more than the representation. For instance, in one example the interface can display the original electronic file, an interactive representation of the electronic file, and/or a dynamically updating preview of the modified electronic file. The user can use the interactive representation to select one or more elements to retain and/or remove. Such interaction includes toggling the state (retain or remove) of the one or more elements until a suitable combination of elements has been selected. As the user selects elements to retain and/or remove, the dynamically updated preview changes to reflect the recent status of the elements. The foregoing provides the user with a real-time view of the original electronic file as well as the effects of removing one or more elements therefrom. In other instances, more or less and/or similar and/or different information can be presented by the presentation component 22. For instance, the representation can be provided to the user, the user can select the portions to retain (or select the portions to remove), and the user can preview the electronic file to see what it will look like without the certain portions.

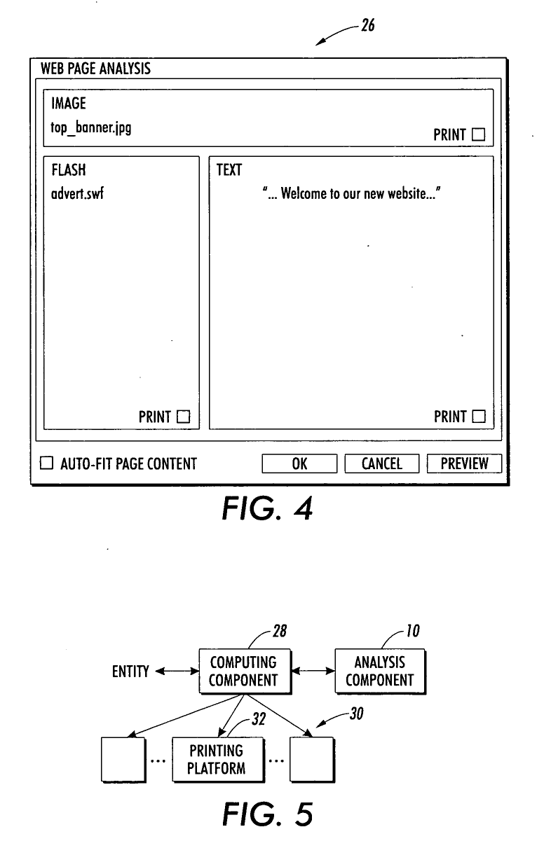

Briefly turning to FIG. 4, a non-limiting example of an interface 26 used to select content to print is illustrated. As depicted, the electronic file is delineated into various categories (e.g., “Image,” “Flash,” and “Text”). Within each category is a description of related content. Each category can be individually selected to be included (or not included) when printing to electronic file. The interface 26 also includes utilities to modify and/or reposition retained elements within the electronic file. For example, in one instance a re-sizing feature provides for automatic and/or manual (e.g., drag and drop, re-size, rotate, flip, etc.) reshuffling of the content of the electronic file, which may reduce vacant space. The interface also provides a preview feature in order to preview the output of the user's selections. In addition, the interface 26 provides mechanisms to save and/or cancel the selections.

Returning to FIG. 3, the re-format component 24 generates a new electronic file based on the representation and/or selected elements therewith. In one instance, the original electronic file is maintained and another electronic file is created. The newly created electronic file can be stored in storage and/or discarded. In another instance, the newly created electronic file can be saved over the original electronic file and/or the original electronic file can be removed from storage. In yet another instance, the newly created electronic file can be printed or otherwise processed. It is to be appreciated that the re-format component 24 is by-passed wherein the representation is provided to anther component(s) for further processing.

FIG. 5 illustrates a non-limiting example in which the analysis component 10 is used to facilitate removing undesired elements from an electronic file in order to mitigate printing undesired elements. The example includes a computing component 28, which can be a computer (e.g., desktop, laptop, hand held, tabletop, etc.), a personal data assistant, a cell phone, and the like. The computing component 28 can be used by an entity such as person, a robot, another computing component (e.g., over a network), etc. The entity can use the computing component 28 to create, modify, and/or serially and/or concurrently convey electronic files to one or more other devices 30, including printers, facsimiles, scanners, plotters, displays, other computing components, etc.

In one particular non-limiting example, the entity may desire to print a webpage. However, the webpage may include various elements that are not related to the topic of interest within the webpage. For example, the webpage may additionally include a header, one or more advertisements, a menu, various images, etc. The entity may desire to print the topic of interest without any, with a portion of, or with all of the extraneous information. With a conventional computing system, the entity would employ techniques such as printing a highlighted (or selected) portion of the webpage and/or copying the webpage to a word processor and manually removing undesired information. Such techniques can be inflexible, complex, and/or time consuming. For example, a typical web browser only allows a user to highlight contiguous sections. Thus, if an undesired inclusion such as advertisements interleaved between desired text, the user is unable to highlight all of the text without highlighting the advertisement. In another example, manually editing the webpage may result in undesired formatting, unidentifiable elements, etc.

One or more of the above-noted deficiencies associated with conventional computing systems can be mitigated through the analysis component 10. For instance, the entity can invoke, via the computing component 28, the analysis component 10 to facilitate removing undesired content from a particular webpage. The webpage can be provided to the analysis component 10 and/or the analysis component 10 can retrieve the webpage (e.g., via a corresponding URL). In one instance, the webpage is obtained via the Internet. In other instance, the webpage can be obtained form storage such as portable memory (e.g., memory stick, CD, DVD, optical disk, magnetic disk, etc.), hard disk, RAM, etc.

Upon receiving the webpage, the analysis component 10 scrutinizes its source code, including text, graphics, tags, comments, etc. The analysis component 10 subsequently identifies the various elements of the webpage. With these components identified, the analysis component 10 generates a representation of the webpage, based on the identified elements. The representation is provided to the computing component 10 and displayed to the entity. The entity can interact with the displayed representation in order to determine which elements to retain and/or which elements to remove. In addition, the entity can modify the retained elements. Suitable modifications include, but are not limited to, resizing, reshaping, rotating, cropping, repositioning, etc. one or more retained elements. The entity can preview the webpage at any time to visualize the webpage with the removed and/or modified elements.

Upon generating a suitable webpage, the entity can have the computing system 10 and/or the analysis component 10 creates a new webpage based on the removed and/or modified elements. The new webpage can subsequently be conveyed to one or more of the devices 30. For example, the computing component 10 can provide the new webpage to a printing platform 32, which will print the webpage. The resulting print will not include the elements in the original webpage denoted as undesired by the entity. This can facilitate prolonging the life of marking media and reduce any clutter associated with unrelated subject matter.

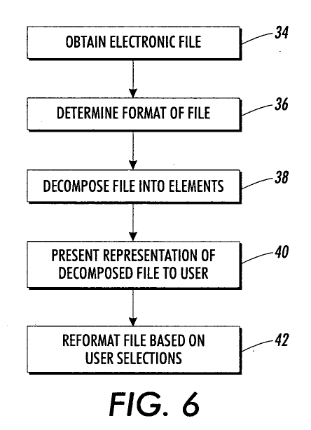

With respect to FIG. 6, a method for identifying and removing various undesired sections of en electronic file illustrated. At 34, an electronic file is obtained. Such file can be associated with a web browser (e.g., a webpage), a word processing document, a spreadsheet, a database, etc. In addition, such file can be obtained from the Internet, portable storage, static storage, volatile storage, non-volatile storage, newly created, etc. At 36, the format of the electronic file is determined. This can be accomplished by receiving such information (e.g., from the source of the electronic file, etc.) and/or determining the format. At 38, the electronic file is decomposed into sets of different elements. This can be achieved via metadata, tags, and/or the like associated with the electronic file. In addition, one or more sets of rules that describe the electronic file can be used to facilitate the decomposition.

At 40, a representation of the decomposition is used to indicate which elements should remain in the electronic file and which elements should be removed from the electronic file. This can be achieved by providing an interactive graphical representation of the electronic file, including the various elements located therein. An entity (e.g., a user, an application, a robot, another computing system, etc.) can interact with the representation and preview the affects of such interaction. In another instance, a default and/or user defined profile can be used to automatically select which elements to retain and which to remove. For example, the profile can be configured to automatically remove all figures. At reference numeral 42, the electronic file can be reformatted based on the retained and/or discarded elements. The modified electronic file can be conveyed for further processing such as, for example, conveyed to a printing platform for printing.

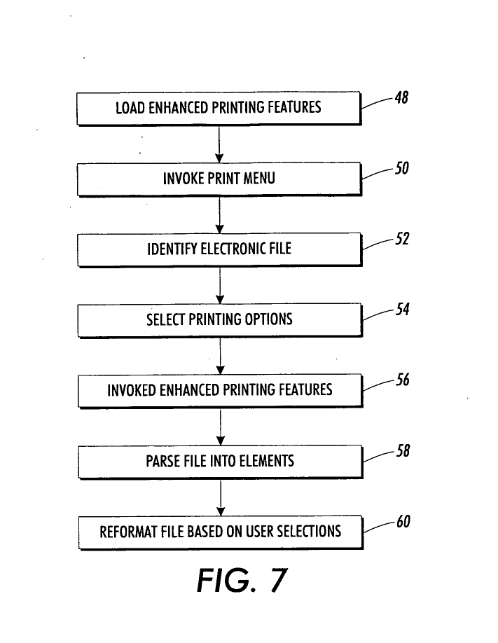

FIG. 7 illustrates a method for removing undesired elements of a webpage during a printing process in order to selectively print sections of interest. Beginning at reference numeral 48, enhanced webpage printing features packed as a printer driver (e.g., monolithic and table-driven), an application, an add-in, a plug-in, part of the operating system, and/or the like are executed by a computing system. The user (e.g., a person, an application, a robot, another computing system, etc.) of the computing system identifies a file to print. At 50, the user invokes the native print menu. At reference numeral 52, the user identifies (manually or automatically) the file as a webpage. In one instance, this can be accomplished by selecting “webpage” as a print job type. At 54, the user employs the native print, which guides the user through various printing options, to suitably format the webpage. Such options include, but are not limited to, designating paper size, color, print tray, etc.

At reference numeral 56, the enhanced webpage printing features are invoked. The URL of the webpage is obtained and used to red the webpage source code. At 58, the webpage is parsed into its various elements. Each element can be displayed to the user and include extracts and/or file information and/or be associated with a mechanism for selecting and/or deselecting elements to print. At 60, the webpage can be reformatted based on the selected options and sent to a printer for processing. It is to be appreciated that the user can further modify the webpage. For example, the user can re-size (e.g., automatically and/or manually fit) the retained elements to minimized dead space, reshuffle the retained elements, etc. Further, the user can preview the modified webpage. Any and/or all modifications can be rolled back, as desired.

It will be appreciated that the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An electronic file decomposition system, comprising:
a parser that decomposes an electronic file into different components based at least in part on metadata of the components;
an interface that presents an interactive representation of the decomposed electronic file to a user who uses the interface to select which components to retain and/or which components to remove; and
a re-formater that generates a new electronic file based on the received electronic file and the user selections.

2. The electronic file decomposition system as set forth in claim 1, wherein the electronic file is one of a webpage, a document, and a spreadsheet.

3. The electronic file decomposition system as set forth in claim 1, wherein the metadata includes at least one of structural, descriptive, and presentational information.

4. The electronic file decomposition system as set forth in claim 1, wherein the components of the electronic file include one or more of text, an image, an advertisement, a hyperlink, an embedded executable.

5. The electronic file decomposition system as set forth in claim 1, further including a previewer that enables a user to preview the new electronic file in order to visualize the consequences of the changes prior to generating the new electronic file.

6. The electronic file decomposition system as set forth in claim 1, wherein the re-formater re-casts the retained components to minimize empty space in the new electronic file.

7. The electronic file decomposition system as set forth in claim 1, further including an identifier that identifies a format of the received electronic file.

8. The electronic file decomposition system as set forth in claim 7, wherein the identifier determines the format from the metadata.

9. The electronic file decomposition system as set forth in claim 1, further including a rules bank that includes one or more algorithms for decomposing the electronic file based on a file format.

10. The electronic file decomposition system as set forth in claim 1, wherein the one or more algorithms describe at least one of a syntax and semantics of the electronic file.

11. The electronic file decomposition system as set forth in claim 1, further including a printing platform that prints the new electronic file.

12. The electronic file decomposition system as set forth in claim 1, wherein the electronic file is programmed in a markup language.

13. The electronic file decomposition system as set forth in claim 1, wherein electronic file decomposition system is implemented in one or more of a printer driver, an application, an add-in, a plug-in, and an operating system.

14. A method for identifying and selectively retaining portions of an electronic file, comprising:
receiving an electronic file;
decomposing the electronic file into different elements based on information about data within the electronic file;
presenting one or more of the different elements to a user who determines which elements to retain; and
creating a new electronic file with the retained elements.

15. The method as set forth in claim 14, further comprising providing a graphical representation of the different elements in which the user selects elements to retain and previews the new electronic file prior to creating it.

16. The method as set forth in claim 14, further including at least one of resizing, reshaping, rotating, cropping, and repositioning the retained elements in the new electronic file.

17. The method as set forth in claim 14, wherein presenting the elements to the user includes providing an interactive graphical representation.

18. The method as set forth in claim 14, wherein the electronic file is one of a webpage, a word processing document, and a spreadsheet.

19. The electronic file decomposition system as set forth in claim 1, wherein the information about the data includes at least one of structural, descriptive, and presentational information.

20. A method for removing components from an electronic file prior to printing in order to discard undesired portions of the electronic file, comprising:
identifying a format of an electronic file;
parsing the electronic file into different components based on the format;
displaying a representation of the electronic file to a user, delineating the electronic file by the different components;
interacting with the user to determine which components to remove;
generating a new electronic file based the components the user selected to discard; and
printing the new electronic file.
